(19) United States
(12) Patent Application Publication
(10) Pub. No.: US 2009/0213754 A1
(43) Pub. Date: Aug. 27, 2009

(54) Device, System, and Method of Group Communication

(76) Inventor: Roie Melamed, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 12/037,098

(22) Filed: Feb. 26, 2008

(51) Int. Cl. H04L 12/28

(52) U.S. Cl. 370/254

(57) ABSTRACT

Device, system and method of group communication. For example, a computing apparatus capable of performing group communication may include a group communication service to communicate as a member of a group-communication-system including a plurality of members linked according to a distributed-hash-table overlay network topology, wherein the group communication service is to link to a set of one or more of the plurality of members according to the distributed-hash-table overlay network topology, and to route to a selected member of the set a group-communication-service message, intended for a destination member of the plurality of members. Other embodiments are described and claimed.

### FIELD

Some embodiments are related to the field of group communication systems.

### BACKGROUND

A Group communication system may provide multipoint to multipoint communication, for example, between members, or processes, organized in a group. The group communication system may include, for example, a cluster of IBM WebSphere Application Servers (WASs). A process may communicate with another process, e.g., a process in the group, or a process included, for example, in another group, by sending a message targeted to a logical name of the process.

The group communication system may include a logical overlay network, which defines logical connections between processes in the system, based on a predefined topology, e.g., a clique topology or a star topology.

In a group communication system based on a clique topology, each process may be required to maintain a reliable connection with every other process in the system, and/or to send “heartbeats” to each of the other processes, in order to monitor a state of each of the other processes. Therefore, a group communication system including a significant number of processes may require a significant number of connections between the processes, which may result in significant system latency and/or a high-probability of erroneous transfer of data.

In a group communication system based on a star topology, every process is connected to a central “leader” process, which connects every pair of processes in the system, such that every message from a first process to a second process is sent from the first process to the “leader” process and from the “leader” process to the second process. Therefore, the “leader” process may be unsuitable for transferring information in a system including a significant amount of processes, and may cause a significant system latency and/or high-probability erroneous transfer of data.

Group communication systems based on other conventional topologies, for example, a hierarchal topology, may have similar and/or additional problems.

### SUMMARY

Some embodiments of the invention include, for example, devices, systems and methods of group communication.

Some embodiments include, for example, a computing apparatus capable of performing group communication. The computing apparatus may include a group communication service to communicate as a member of a group-communication-system including a plurality of members linked according to a distributed-hash-table overlay network topology. The group communication service may link to a set of one or more of the plurality of members according to the distributed-hash-table overlay network topology, and to route to a selected member of the set a group-communication-service message intended for a destination member of the plurality of members.

In some demonstrative embodiments, the group communication service maintains a finger table including one or more distributed-hash-table identifiers of the one or more members of the set, respectively.

In some demonstrative embodiments, the plurality of members include N members, and the finger table includes no more than an order of log(N) distributed-hash-table identifiers.

In some demonstrative embodiments, an identifier of the selected member is closer than other identifiers of the finger table to an identifier of the destination member.

In some demonstrative embodiments, the group communication service is to route a broadcast message intended for each of the plurality of members to no more than two members of the set of members.

In some demonstrative embodiments, the group communication service is capable of dividing the overlay network into first and second logical intervals including first and second members of the set, respectively; and routing the broadcast message to the first and second members with indications of the first and second logical intervals, respectively.

In some demonstrative embodiments, the first member is immediately successive to the member of the group communication service, the first logical interval spans between the first member and a member preceding the second member, and the second logical interval spans between the second member and the member of the group communication service.

In some demonstrative embodiments, the distributed-hash-table overlay network topology includes a Chord topology.

In some demonstrative embodiments, the plurality of members include N members, and the set may include no more than an order of log(N) members.

In some demonstrative embodiments, the message may include a message received from either another member of the plurality of members or from an application of the computing apparatus.

Some embodiments may include, for example, a computer program product including a computer-useable medium including a computer-readable program, wherein the computer-readable program when executed on a computer causes the computer to perform methods in accordance with some embodiments of the invention.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a group communication system, in accordance with some demonstrative embodiments;

FIG. 2 is a schematic block diagram illustration of a plurality of members of a group communication system, in accordance with some demonstrative embodiments;

FIG. 3 is a schematic block diagram illustration of a broadcast tree scheme, in accordance with demonstrative embodiments; and

FIG. 4 is a schematic flow-chart of a method of group communication, in accordance with some demonstrative embodiments.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items. Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments of the invention may utilize wired communication and/or wireless communication.

The term “group communication system” as used herein may include, for example, a group of multiple members, wherein each member is capable of communicating with another member in the group, via a pre-defined logical network which may define one or more routing schemes and/or logical connections between the members of the group. For example, a member may send a message directly or un-directly to one or more other members, or receive a message from another member, e.g., according to the one or more routing schemes.

The term “member”, as used herein, includes, or may be implemented by, for example, a computing process, a computing device, an application, a processor, a storage volume able to send and/or receive information, or the like. In one example, a member may be implemented by one or more computing devices, and/or a computing device may include one or more members.

The term “Distributed Hash Table (DHT)” as used herein includes, for example, a table of identifiers of substantially all members in a group communication system including a plurality of members, wherein information of the table may be distributed between the plurality of members. In one example, each member may include a portion of the DHT, for example, as part of a routing table (also referred to as “finger table”). The DHT may be distributed according to a topology of a logical overlay network implemented by the group communication system. A DHT may be implemented, for example, according to a Chord overlay topology, a Content Addressable Network topology, a Pastry network topology, a Tapestry network topology, or the like.

At an overview, some embodiments provide devices, systems and/or methods of scalable group communication systems. In some embodiments, substantially each member of a group communication system includes a Group Communication Service (GCS), responsible for performing communication with other members of the system. In some embodiments, multiple GCSs may self-organize, e.g., automatically, to construct a logical overlay network, for example, a DHT overlay network, logically connecting members of the system. The DHT overlay network may include, for example, a protocol for constructing a Chord overlay, corresponding to a Chord topology. In one example, in a group communication system including N members connected by a Chord overlay network, the DHT may be distributed, for example, between the N members, e.g., such that each member maintains a finger table including an order of log N identifiers of other members in the group.

In some embodiments, the GCS of a member may include a transport layer, which may include a routing module, a broadcast module, and/or an end-to-end reliability module. The routing and/or broadcast modules may include schemes for routing, delivering and transferring information, for example, a message, e.g., a point-to-point message and/or a broadcast message, between members of the system, according to the DHT topology.

In some embodiments, the routing module may be capable of routing a message from the member to a destination member. The message may be routed, for example, according to the finger table maintained by the member and additional finger tables of other members. The message may be routed to the destination member in an order of log N hops, e.g., if a Chord overlay network topology is implemented.

In some embodiments, the broadcast module may be capable of routing a broadcast message from the member to substantially all other members of the group. The broadcast message may be routed to the members of the group communication system by dynamically creating a multicast tree over the overlay network, and routing the broadcast message over the tree. The broadcast message may be received by substantially all the members of the group, for example, within an order of log N steps, or hops, e.g., if a Chord overlay network topology is implemented. As a result, an order of N messages overall may be sent within the group. Therefore, routing the broadcast message according to the multicast tree may result in relatively low latency.

In some embodiments, the end-to-end reliability module may ensure successful arrival of the routed message to the destination member, and/or to substantially all members in the system, by using a point-to-point communication module, for example, a Reliable Multicast Messaging (RMM).

In some embodiments, the group communication system may overcome message-sending failures, e.g., by utilizing links of the DHT overlay network.

In some embodiments, the system utilizing the DHT overlay network may be scaled to include, for example, multiple hundreds of processes, e.g., more than 500 or 1000 processes. In some embodiments, the system utilizing the DHT overlay, may be, for example, resilient to failures, since generally each failure may be handled locally, allowing in case of a broadcast failure to send no more than an order of (logN)² messages in order to self-re-organize the DHT overlay network, e.g., automatically.

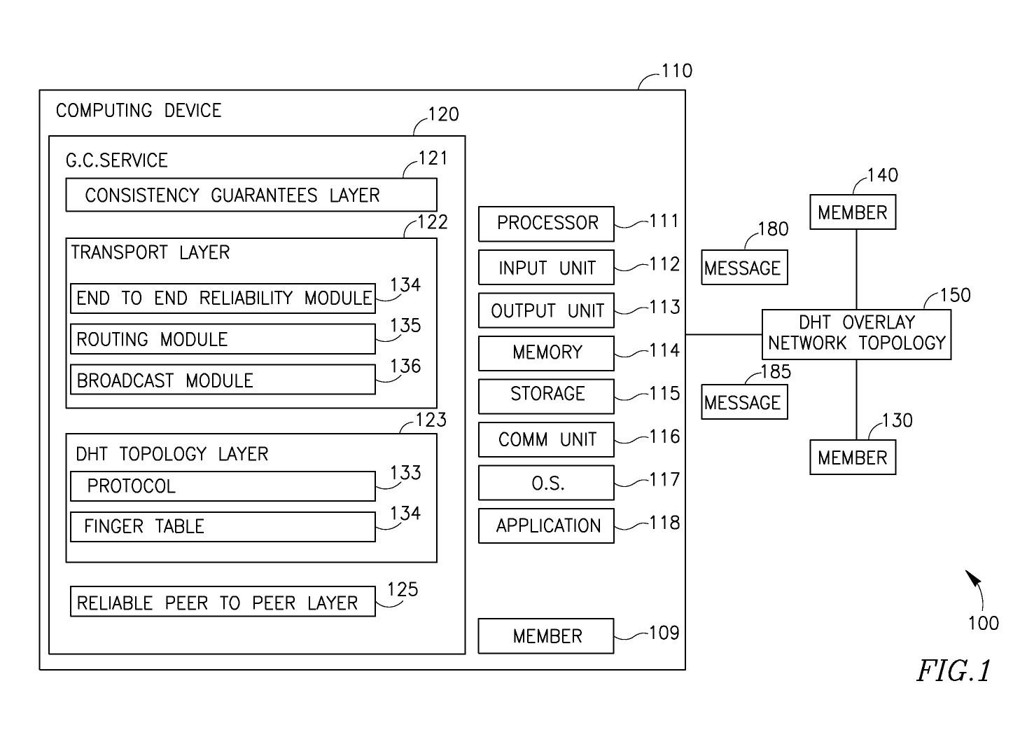

FIG. 1 schematically illustrates a group communication system 100, in accordance with some demonstrative embodiments of the invention. System 100 may be or may include, for example, an interconnected, or linked network of multiple members, which may include or may be part of computers, computing devices, processes, a combination thereof, or the like.

In some embodiments, system 100 may include a plurality of members, e.g., members 130 and 140, linked according to a DHT overlay network topology 150. In one example, DHT overlay network topology may include a Chord topology. In other examples, topology 150 may include a Content Addressable Network topology and/or any other suitable DHT topology.

In some embodiments, system 100 may include a computing device 110, capable of performing group communication. Computing device 110 may include a Group Communication Service (GCS) 120, able to communicate as a member 109 of system 100, e.g., as described below. Although only members 109, 130, and 140 are illustrated in FIG. 1 for demonstrative purposes, system 100 may include any other suitable number of members, for example, multiple hundreds of members. In one example, the group communication system of FIG. 1 may include at least one hundred members, for example, at least 500 members, e.g., at least 1000 members.

In some embodiments, GCS 120 may link to a set of one or more of the members included in system 100 according to DHT overlay network topology 150; and may route a message 180 intended for a destination member of system 100, e.g., via a selected member of the set. In some embodiments, system 100 may include N members, and the set may include no more than an order of log N members, e.g., as described in detail below.

In some embodiments, members 109, 130 and/or 140 may be interconnected, or linked, through a physically wired network, a wireless network, or a combination thereof. The network or networks may include, for example, a cable network, the internet, connecting bridges, hubs, switches, routers, optical fibers, Ethernet, a wired or wireless Local Area Network, Global area network, Power line communication, other suitable network connections, or a combination thereof. One or more of members 109, 130, and 140 may be in a physical proximity to one another, mutually remote, or a combination thereof.

In some embodiments, members 109, 130, and/or 140 may establish a logical overlay network that utilizes the physically wired or wireless connection network for physically transferring the data or information between members 109, 130 and/or 140. The logical overlay network may define direct and indirect logical communication links between members 109, 130, and/or 140, according to DHT overlay network topology 150.

In some embodiments, GSC 120 may include a DHT topology layer 123 including a protocol 133 to define DHT overlay network topology 150. In some embodiments, the members of system 100 may be able to self-organize into DHT overlay network topology 150 based on topology layer 123, e.g., automatically and/or without requiring the involvement of an administrator. In one example, a topology layer 123 may be implemented by a file maintained, e.g., by each member of system 100, and containing, for example, an identity and/or address, e.g., an Internet Protocol address and/or a port, of other members of system 100. Members 109, 130, and/or 140 may self-organize into DHT overlay network topology 150, e.g., automatically and/or without requiring the involvement of an administrator, for example, by using topology layer 123 to construct logical communication links between members 109, 130, and/or 140, according to DHT overlay network topology 150. For example, member 109 may use topology layer 123 to define the set of one or more members, to which member 109 is directly linked.

In some embodiments, topology layer 123 may include a finger table 124, including a list of identifiers of the set of the directly linked members. In some embodiments, finger table 124 may include an order of log N identifiers, for example, if system 100 includes N members, e.g., as described in detail below.

In some embodiments, GCS 120 may include a transport layer 122 to transfer, receive and/or send information, to and from member 109. The information may include, for example, point to point messages, e.g., a point-to-point message 180; and/or broadcast messages, e.g., a broadcast message 185, as described below.

In some embodiments, message 180 and/or broadcast message 185 may be, or may include, for example, a message externally received from another member of system 100, a message internally received from an application 118 of computing device 110, and/or any other suitable message.

In some embodiments, transport layer 122 may include a routing module 135 to route message 180 from member 109 to the destination member. Module 135 may route the message in a point-to-point-fashion, based on the DHT overlay network topology 150. In some embodiments, member 109 may route message 180 to a member of the set of members, whose identifier is closer than other identifiers of members of the set, to an identifier of the destination member, as described in detail below. In some embodiments, the message may be routed to the destination member in an order of log N hops, e.g., as described below.

In some embodiments, transport layer 122 may include a broadcast module 136 to route broadcast message 185 from member 109 to multiple members of system 100, for example, substantially all members of system 100. In some embodiments, broadcast module 136 may include an algorithm to create a multicast tree, logically routing the message 185, intended to substantially all members of system 100.

In some embodiments, broadcast module 136 may directly route message 185, to no more than two members of the set of members of finger table 124. For example, broadcast module 136 may be capable of dividing system 100 into first and a second logical intervals, including first and a second members of the set of finger table 124, respectively; and routing broadcast message 185 to the first and second members with an indication of the first and second logical intervals, respectively, e.g., as described in detail below.

In some embodiments, the first member is immediately successive to member 109, the first logical interval spans between the first member and a member preceding the second members, and the second logical interval spans between the second member and member 109. In some embodiments, message 185 may reach substantially every member of system 100 in an order of log N hops, as described in detail below.

In some embodiments, GCS 120 may include a reliable peer to peer layer 125, to ensure a reliable, ordered, delivery of data or information, for example, messages 180 and/or 185. Layer 125 may be, or may include, a Transmission Control Protocol (TCP), a RMM, and/or or any other suitable reliable peer-to-peer layer.

In some embodiments, transport layer 122 may include an end-to-end reliability module 134, to ensure reception of sent messages, for example, messages 180 and/or 185, by one or more intended recipients of the messages. Module 134 may implement RMM, TCP, and/or other suitable layers, to detect failure of reception of the messages, and/or modulate or route an alternative path for the messages.

In some embodiments, computing device 110 may also include, for example, a processor 111, an input unit 112, an output unit 113, a memory unit 114, a storage unit 115, and/or a communication unit 116. Computing device 110 may optionally include other suitable hardware components and/or software components.

Processor 111 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 111 may execute instructions, for example, resulting in GCS 120, application 118, an operating system 117 and/or any other suitable process or application.

Input unit 112 includes, for example, a keyboard, a keypad, a mouse, a touch-pad, a track-ball, a stylus, a microphone, or other suitable pointing device or input device. Output unit 113 includes, for example, a monitor, a screen, a Cathode Ray Tube (CRT) display unit, a Liquid Crystal Display (LCD) display unit, a plasma display unit, one or more audio speakers or earphones, or other suitable output devices. Memory unit 114 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 115 includes, for example, a hard disk drive, a floppy disk drive, a Compact Disk (CD) drive, a CD-ROM drive, a Digital Versatile Disk (DVD) drive, or other suitable removable or non-removable storage units. Memory unit 114 and/or storage unit 115, for example, store data processed by computing device 110. Memory unit 114 and/or storage unit 115 may store, for example, instructions resulting in GCS 120, e.g., when executed by processor 111.

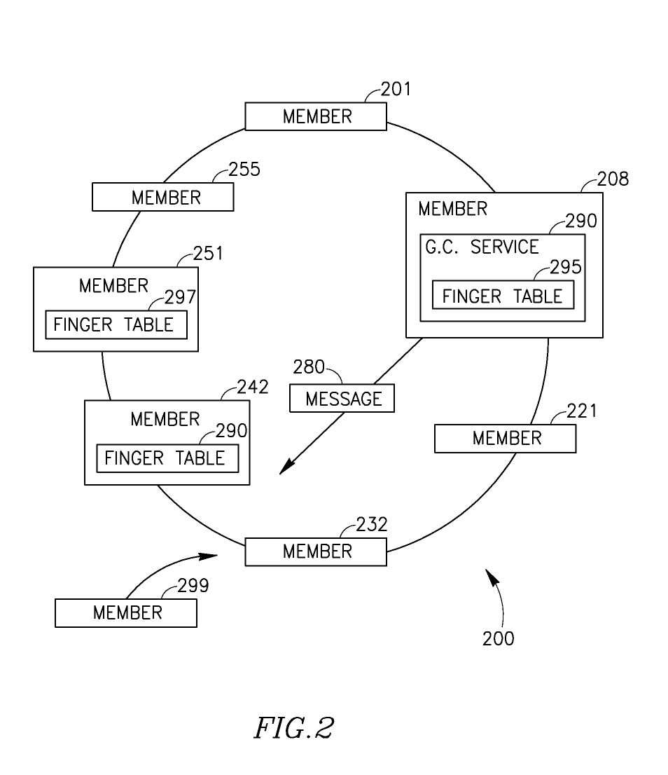

In some embodiments, components of computing device 110 may be enclosed in a common housing or packaging, and may be interconnected or operably associated using one or more wired or wireless links. In other embodiments, components of computing device 110 may be distributed among multiple or separate devices or locations, may be implemented using a client/server configuration or system, or may communicate using remote access methods. FIG. 2 schematically illustrates a plurality of members of a group communication system 200, in accordance with some demonstrative embodiments. In some non-limiting embodiments, system 200 may perform the functionality of system 100 (FIG. 1), and/or one or more members of system 200 may perform the functionality of member 109 (FIG. 1).

In some embodiments, system 200 may include, for example, a plurality of N members, e.g., members 208, 221, 232, 242, 251, 255, and/or 201, logically linked according to a DHT overlay network topology, e.g., topology 150 (FIG. 1). Although a plurality of seven members 208, 221, 232, 242, 251, 255 and 201, are illustrated for demonstrative purposes, system 200 may include any other suitable number of members, for example, multiple hundreds of members. In one example, system 200 may include at least one hundred members, for example, at least 500 members, e.g., at least 1000 members.

In some embodiments, a plurality of DHT identifiers may be assigned, e.g., uniquely, to the plurality of members of system 200, for example, according to any suitable hash function, e.g., a Secure Hash Algorithm-1 (SHA-1) function. In some embodiments, an identifier, denoted qⱼ, assigned to a member having an identity index j may include, for example, a string of t bits, representing an integer number in a range between 0 and 2^{t}−1. For example, member 201 may have an identifier number q₂₀₁=1; member 208 may have an identifier number q₂₀₈=8; member 221 may have an identifier number q₂₂₁=21; member 232 may have an identifier number q₂₃₂=32; member 242 may have an identifier number q₂₄₂=42; member 251 may have an identifier number q₂₅₁=51; and member 255 may have an identifier number q₂₅₅=55.

In some embodiments, the DHT overlay network topology of system 200 may be logically arranged cyclically according to the identifiers of the members. In one example, the members of system 200 may be logically arranged in a logical closed circle according to an increasing order of the identifiers. A member having a highest identifier number may be logically adjacent to a member having a lowest identifier number, “closing” the circle. For example, as shown in FIG. 2, the members of system 200 may be cyclically arranged in the following order: member 201, member 208, member 221, member 232, member 242, member 251, and member 255.

In some embodiments, member 208 may include a GCS 290, to communicate as a member of system 200. For example, GCS 290 may perform the functionality of GCS 121 (FIG. 1). In some embodiments, GCS 290 may include a finger table 295 including a set of one or more DHT identifiers of set of one or members of system 200, respectively. In one example, finger table 295 may include an order of log N identifiers, for example, at most t identifiers indexed: i=1, 2, . . . , t, wherein an i-th identifier includes identifier number qᵢ.

As a demonstrative example, the DHT overlay network topology includes a Chord topology, and an i-th identifier of finger table 295 may include an identifier number qᵢ exceeding q₂₀₈ by 2⁽ⁱ⁻¹⁾, namely, qᵢ=8+2⁽ⁱ⁻¹⁾, if a member of system 200 corresponds to the identifier number qᵢ. Otherwise, the i-th identifier may include an identifier of a member of system 200 having a smallest identifier number greater than 8+2⁽ⁱ⁻¹⁾. In some embodiments, if for some 1<i<t, a member of system 200 having an identifier number equal to, or greater than 8+2ⁱ⁻¹ does not exist, the i-th identifier of finger table 295 may be a last identifier of finger table 295, and may include an identifier number of a member having a smallest identifier number of system 200. For example, finger table 295 may include the identifiers q₂₂₁, q₂₃₂, q₂₄₂ and q₂₀₁, corresponding to indexes i=2, 3, 4, and 5, respectively.

In some embodiments, member 208 may route a message to one or more members of system 200, e.g., as described below.

In some embodiments, message 280 may include a point to point message 280, e.g., message 180 (FIG. 1), intended for a destination member of system 200, e.g., as described below.

In some embodiments, e.g., if the DHT overlay network topology includes a Chord topology, member 208 may route message 280 directly to the destination member, e.g., if an identifier of destination member (“the destination identifier”) is included in finger table 295. Member 208 may route message 280 to a member k (“the selected member”) of finger table 295, e.g., if finger table 295 does not include the destination identifier. The selected member may have an identifier qₖ, wherein qₖ is a closest number to the destination identifier among identifiers included finger table 295, e.g., that is smaller to the destination identifier. In some embodiments, the selected member may route message 280, according to a similar routing scheme. For example, if the destination identifier is included in a finger table of the member k, then member k may route message 280 directly to the destination member. Otherwise, the member k may route message 280 to another member k2 corresponding to an identifier qₖ₂ of the finger table of member k, wherein qₖ₂ is a closest number to the destination identifier among numbers included the finger table of member k, e.g., that is smaller to the destination identifier. In some embodiments, the routing scheme may be repeated, e.g., until message 280 arrives at the destination member. In some embodiments, the DHT overlay network topology may ensure successful arrival of message 280 to the destination member, e.g., if the message 280 is routed according to the scheme.

In one example, the destination member may include member 255 represented by the identifier q₂₅₅=55, which is not included in finger table 295. Member 208 may route message 280 to member 242, corresponding to the identifier q₂₄₂=42 which is included in finger table 295, wherein q₂₄₂ is a closest number to the identifier q₂₅₅=55 among identifiers included finger table 295, that is smaller or equal to 55. Member 242 may include, for example, a finger table 290, including the identifiers q₂₅₁, q₂₀₁ and q₂₃₂. Member 242 may route message 280 to member 251, e.g., since finger table 290 does not include the identifier q₂₅₅. Member 251 may include a finger table 297, which may include the identifier q₂₅₅. Therefore, member 251 may route message 280 to destination member 255. Accordingly, message 280 may be routed from member 208 to member 255 within three hops.

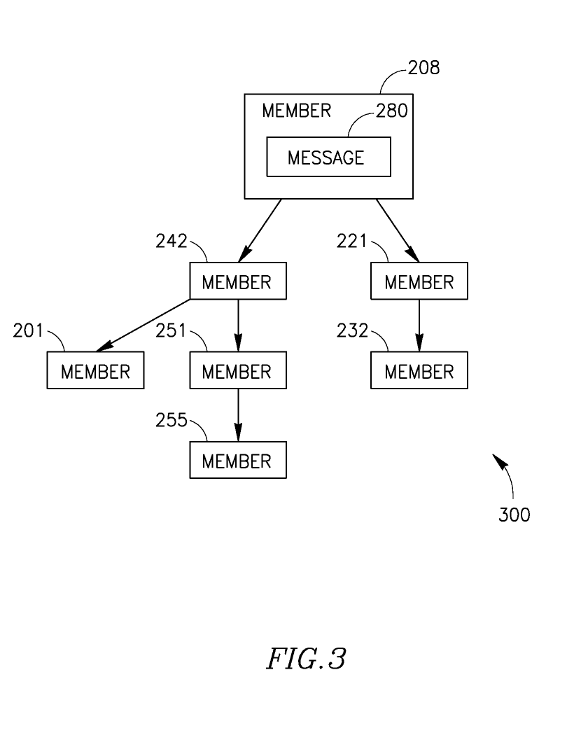

In some embodiments, message 280 may include a broadcast message e.g., message 185 (FIG. 1). Member 208 may broadcast message 280 to substantially every member of system 200 according to a broadcast scheme, e.g., as described below. Reference is also made to FIG. 3, which schematically illustrates a broadcast tree scheme 300, in accordance with some embodiments. In some non-limiting embodiments, scheme 300 may be implemented by system 200 to broadcast message 280.

In some embodiments, e.g., if the DHT overlay network topology includes a Chord topology, member 208 may route message 280 to no more than two members included in finger table 295. Each of the two members may further route message 280 to no more than two other members included in respective finger tables of the two members, and so on, e.g., until message 280 reaches all members of system 200. In some embodiments, message 280 may be received by substantially every member of system 200, in no more than an order of log N hops, resulting in latency of order of log N.

In some embodiments, member 208 may logically divide a logical interval corresponding to all identifiers included in finger table 295 into first and second logical intervals including, for example, a substantially similar number of consecutive identifiers. The first logical interval may span between a first member immediately successive to member 208 (“the successor of member 208”) and a member immediately preceding a second member, denoted, qᵢₙₜ. The second member may be determined based, for example, on the number of bits t and/or the identifier of a member of system 200, e.g., member 208, which originating message 280. In one example, the second member may have a smallest identifier included in finger table 295, which is greater than or equal to an identifier q₂₀₈+2^{t}−1. The second logical interval may include substantially all other identifiers of finger table 295. For example, the second logical interval may span between the second member qᵢₙₜ, and a last identifier of finger table 295.

In one example, the first interval may span between members 221 and 232, and the second interval may span between members 242 and 208, e.g., including members 242, 251, 255 and 201. In some embodiments, member 208 may send message 280, e.g., as first and second messages, to only first and second members, respectively, of finger table 295. For example, as shown in FIG. 3, member 208 may send message 280 to a first member of the first interval, e.g., member 221, and to a first member of the second interval, e.g., member 242. Member 208 may also send to the first and second members, indications of the first and second intervals, respectively, for example, defining, or indicating the interval that the respective first member is included in. For example, member 208 may send to member 221 a definition of the first interval, and send member 232 a definition of the second interval. In some embodiments, each of the first and second members may logically divide the respective first and second intervals into two sub-intervals and route message 280 to members of the sub-intervals, and so on.

For example, as shown in FIG. 3, member 221 may receive message 280, may divide the first interval into a sub-interval including member 232, and may route message 280 to member 232. Member 242 may receive message 280, may divide the second interval into a first sub-interval including member 201 and a second sub-interval including members 251 and 255, and may send message 280 to members 201 and 251. In some embodiments, further sub-divisions are applied, e.g., until message 280 successfully reaches substantially every member of system 200. For example, member 251 may divide the sub-interval associated with member 251 into another sub-sub-interval including member 255, and route message 280 to member 255.

In some embodiments, the broadcast scheme of FIG. 3 may overcome broadcast failures, e.g., by utilizing links of multiple finger tables of the members of system 200.

In some embodiments, a member of system 200, e.g., member 208 may maintain logical links to a member immediately preceding member 208 (“the predecessor member”), e.g., member 201, and/or to a member immediately succeeding member 208 (“the successor member”), e.g., member 221. Member 208 may additionally maintain logical links to a successor of the successor member, e.g., member 232, and/or to a predecessor of the predecessor member, e.g., member 255. In some embodiments, member 208 may maintain logical links to additional successors and/or predecessors, for example, an order of log N successors and predecessors, e.g., to ensure global connectivity of the closed circle of system 200.

In some embodiments, a member, e.g., a member 299, not logically linked to system 200 (“the new member”), may logically link to (“join”) system 200. In some embodiments, member 299 may be capable of linking to system 200 by self-locating at a location of member 299 within system 200. For example, member 299 may communicate with a member of system 200 (“the rendezvous member”), e.g., using an IP address and/or port address of the rendezvous member, to receive an a finger table of the rendezvous member. Member 299 may determine an identifier of member 299, use the finger table of the rendezvous member to determine an identifier of a member of system 200 having an identity immediately preceding the identity of member 299 (“the preceding member”), and logically join system 200 as a successor of the preceding member, for example, by establishing a finger table utilizing the finger table of the preceding member.

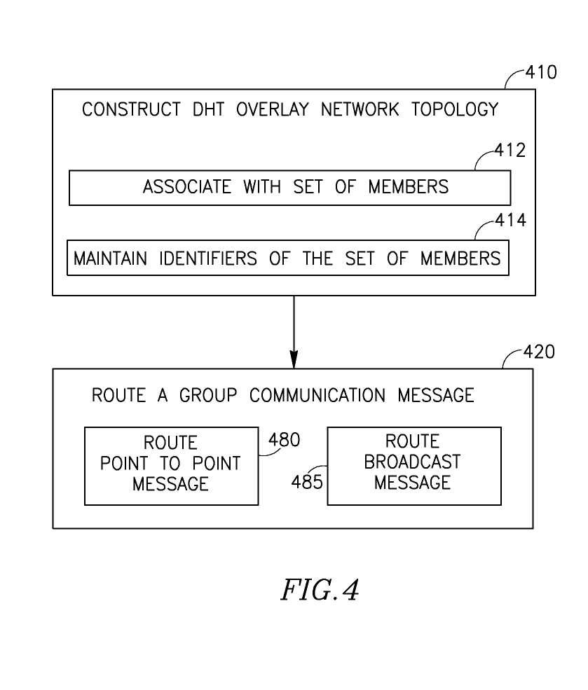

FIG. 4 is a schematic flow-chart of a method of group communication, in accordance with some embodiments. In some non-limiting embodiments, one or more operations of the method of FIG. 4 may be implemented, for example, by one or more elements of a group communication system, e.g., system 100 (FIG. 1) and/or system 200 (FIG. 2), and/or by other suitable units, devices and/or systems.

As indicated at block 410, in some embodiments, the method may include, for example constructing a DHT overlay network topology, to associate between a plurality of members of a group communication system. For example, the DHT overlay network topology may include DHT overlay network topology 150 (FIG. 1), e.g., a Chord topology.

As indicated at block 412, in some embodiments, constructing the DHT overlay network topology may include associating the plurality of members with pluralities of respective sets of the members.

As indicated at block 414, constructing the DHT overlay network topology may include maintaining by the plurality of members identifiers of members of the plurality of sets, respectively. In one example, the plurality of members may include N members, and substantially each set may include no more than an order of log N members. For example, finger table 295 (FIG. 2) may maintain identifiers of a set of members associated with member 208 (FIG. 2), e.g., as described above.

As indicated at block 420, in some embodiments the method may include routing a group-communication message from a first member of the plurality of members to at least a second member of the plurality of members over the DHT overlay network topology. As indicated at block 480, routing the message may include, for example, routing a point to point message, e.g., as described above. As indicated at block 485, routing the message may include routing a broadcast message, e.g., as described above.

Other suitable operations or sets of operations may be used in accordance with embodiments of the invention.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A computing apparatus capable of performing group communication, the apparatus comprising:
a group communication service to communicate as a member of a group-communication-system including a plurality of members linked according to a distributed-hash-table overlay network topology,
wherein said group communication service is to link to a set of one or more of said plurality of members according to said distributed-hash-table overlay network topology, and to route to a selected member of said set a group-communication-service message intended for a destination member of said plurality of members.

2. The computing apparatus of claim 1, wherein said group communication service maintains a finger table including one or more distributed-hash-table identifiers of the one or more members of said set, respectively.

3. The computing apparatus of claim 2, wherein said plurality of members include N members, and wherein said finger table includes no more than an order of log(N) distributed-hash-table identifiers.

4. The computing apparatus of claim 2, wherein an identifier of said selected member is closer than other identifiers of said finger table to an identifier of said destination member.

5. The computing apparatus of claim 1, wherein said group communication service is to route a broadcast message intended for each of said plurality of members to no more than two members of said set of members.

6. The computing apparatus of claim 5, wherein said group communication service is capable of dividing said overlay network into first and second logical intervals including first and second members of said set, respectively; and routing said broadcast message to said first and second members with indications of said first and second logical intervals, respectively.

7. The computing apparatus of claim 6, wherein said first member is immediately successive to the member of said group communication service, wherein said first logical interval spans between said first member and a member preceding said second member, and wherein said second logical interval spans between said second member and the member of said group communication service.

8. The computing apparatus of claim 1, wherein said distributed-hash-table overlay network topology comprises a Chord topology.

9. The computing apparatus of claim 1, wherein said plurality of members include N members, and wherein said set includes no more than an order of log(N) members.

10. The computing apparatus of claim 1, wherein said message comprises a message received from either another member of said plurality of members or from an application of said computing apparatus.

11. A method of group communication, the method comprising:
constructing a distributed-hash-table overlay network topology to associate between a plurality of members of a group-communication-system; and
routing a group-communication message from a first member of said plurality of members to a second member of said plurality of members over said distributed-hash-table overlay network topology.

12. The method of claim 11, wherein said constructing comprises associating said plurality of members with a plurality of respective sets of said members.

13. The method of claim 12, wherein said plurality of members include N members, and wherein each of said sets includes no more than an order of log(N) members.

14. The method of claim 12, wherein routing said message comprises routing a broadcast message intended for each of said plurality of members to no more than two members of a set of members associated with said first member.

15. The method of claim 14, wherein routing said broadcast message comprises:
dividing said overlay network into first and second logical intervals including first and second members of said set, respectively; and
routing said broadcast message to said first and second members with indications of said first and second logical intervals, respectively.

16. The method of claim 15, wherein said first member is immediately successive to the member of said group communication service, wherein said first logical interval spans between said first member and a member preceding said second member, and wherein said second logical interval spans between said second member and the member of said group communication service.

17. The method of claim 11, wherein said distributed-hash-table overlay network topology comprises a Chord topology.

18. A group communication system comprising:
a plurality of members logically linked according to a distributed-hash-table overlay network topology,
wherein a first member of said plurality of members is capable of routing a group-communication message to a second member of said plurality of members over said distributed-hash-table overlay network topology.

19. The group communication system of claim 18, wherein said first member is capable of routing to no more than two members a broadcast message intended for each of said plurality of members.

20. The group communication system of claim 18, wherein said plurality of members include N members associated with a plurality of N respective sets of said members, and wherein each of said sets includes no more than an order of log(N) members.

21. The group communication system of claim 18, wherein said plurality of members includes at least one hundred members.

22. The group communication system of claim 21, wherein said plurality of members includes at least five hundred members.

23. A computer program product comprising a computer-useable medium including a computer-readable program, wherein the computer-readable program when executed on a computer causes the computer to:
communicate as a member of a group-communication-system including a plurality of members linked according to a distributed-hash-table overlay network topology by linking to a set of one or more of said plurality of members according to said distributed-hash-table overlay network topology; and
route to a selected member of said set a group-communication-service message intended for a destination member of said plurality of members.

24. The computer program product of claim 23, wherein said plurality of members include N members, and wherein the computer-readable program causes the computer to maintain a finger table including no more than an order of log(N) distributed-hash-table identifiers of no more than an order of log(N) members, respectively.

25. The computer program product of claim 23, wherein the computer-readable program causes the computer to route a broadcast message intended for each of said plurality of members to no more than two members of said set of members.
